(19) United States
(12) Patent Application Publication
(10) Pub. No.: US 2024/0016357 A1
(43) Pub. Date: Jan. 18, 2024

(54) ROBOTIC CLEANER

(71) Applicant: SHARKNINJA OPERATING LLC, NEEDHAM, MA (US)

(72) Inventors: Simon HUGHES, London (GB); Zhanglin Liu, Beijing (CN); Yi hui ZHANG, Shenzhen (CN); Yafei Shen, Beijing (CN); Wulin Tian, Beijing (CN); Scott TEUSCHER, Advance, NC (US); John LEWIS, NEEDHAM, MA (US); Hamish THOMPSON, London (GB)

(21) Appl. No.: 17/889,747

(22) Filed: Aug. 17, 2022

Related U.S. Application Data
(63) Continuation of application No. PCT/CN2022/105687, filed on Jul. 14, 2022.

(51) Int. Cl. A47L 11/40; G05D 1/02

(52) U.S. Cl. CPC A47L 11/4005; A47L 11/4011; G05D 1/0225; A47L 2201/022; A47L 2201/04; G05D 2201/0203

(57) ABSTRACT

A robotic cleaning system may include a docking station, a robotic cleaner that includes at least one of a first set of robot charging contacts or a second set of robot charging contacts, the first and second sets of robot charging contacts being configured to electrically couple the robotic cleaner to the docking station, a dust cup configured to removably couple to the robotic cleaner, and a mop module configured to removably couple to the robotic cleaner. When the mop module is coupled to the robotic cleaner, the robotic cleaner may be configured to electrically couple to the docking station using the first set of robot charging contacts. When the mop module is not coupled to the robotic cleaner, the robotic cleaner may be configured to electrically couple to the docking station using the second set of robot charging contacts.

### TECHNICAL FIELD

The present disclosure is generally related to robotic cleaners and more specifically related to robotic cleaner docking behaviors associated with robotic cleaner configuration(s).

### BACKGROUND INFORMATION

Robotic cleaners are configured to autonomously clean a surface (e.g., a floor). An example robotic cleaner is configured to carry out one or more cleaning behaviors while traversing the surface. The cleaning behaviors may include one or more of a wet cleaning behavior and/or a dry cleaning behavior. For example, the robotic cleaner may include a mop module (for a wet cleaning behavior) and a dust cup (for a dry cleaning behavior). In this example, the mop module may be removably coupled to the robotic cleaner (e.g., such that the robotic cleaner may carry out a dry cleaning only behavior and/or for refilling of the mopping module).

### BRIEF DESCRIPTION OF THE DRAWINGS

These and other features and advantages will be better understood by reading the following detailed description, taken together with the drawings, wherein:

FIG. 1 shows a schematic example of a robotic cleaner, consistent with embodiments of the present disclosure.

FIG. 2 shows a schematic example of a robotic cleaning system, consistent with embodiments of the present disclosure.

FIG. 3 shows a perspective view of a robotic cleaner having a dust cup coupled thereto, consistent with embodiments of the present disclosure.

FIG. 4 shows a perspective view of the robotic cleaner of FIG. 3 having a mop module coupled thereto, consistent with embodiments of the present disclosure.

FIG. 5 shows a bottom view of the robotic cleaner of FIG. 3, consistent with embodiments of the present disclosure.

FIG. 6 shows a perspective front view of the dust cup of FIG. 3, consistent with embodiments of the present disclosure.

FIG. 7 shows a perspective rear view of the dust cup of FIG. 3, consistent with embodiments of the present disclosure.

FIG. 8 shows a bottom view of the robotic cleaner of FIG. 4, consistent with embodiments of the present disclosure.

FIG. 9 shows a perspective view of the robotic cleaner of FIG. 3 docking with a docking station according to a second charging contact docking behavior, consistent with embodiments of the present disclosure.

FIG. 10 shows a perspective view of the robotic cleaner of FIG. 3 carrying out the second charging contact docking behavior of FIG. 9, consistent with embodiments of the present disclosure.

FIG. 11 shows a perspective view of the robotic cleaner of FIG. 3 carrying out the second charging contact docking behavior of FIG. 9, consistent with embodiments of the present disclosure.

FIG. 12 shows a perspective view of the robotic cleaner of FIG. 3 carrying out the second charging contact docking behavior of FIG. 9, consistent with embodiments of the present disclosure.

FIG. 13 shows a perspective view of the robotic cleaner of FIG. 3 carrying out the second charging contact docking behavior of FIG. 9, consistent with embodiments of the present disclosure.

FIG. 14 shows a perspective view of the robotic cleaner of FIG. 3 docking with the docking station of FIG. 9 according to a first charging contact docking behavior, consistent with embodiments of the present disclosure.

FIG. 15 shows a perspective view of the robotic cleaner of FIG. 3 carrying out the first charging contact behavior of FIG. 14, consistent with embodiments of the present disclosure.

FIG. 16 shows a perspective view of the robotic cleaner of FIG. 3 docked with the docking station of FIG. 9 and having a mop module that is being removed therefrom, consistent with embodiments of the present disclosure.

FIG. 17 shows a perspective view of the robotic cleaner of FIG. 3 docked with the docking station of FIG. 9 and having the mop module of FIG. 16 replaced with a dust cup, consistent with embodiments of the present disclosure.

FIG. 18 shows a perspective view of the robotic cleaner of FIG. 3 docked with the docking station of FIG. 9 and having the dust cup of FIG. 17 coupled thereto, consistent with embodiments of the present disclosure.

### DETAILED DESCRIPTION

The present disclosure is generally related to a robotic cleaning system having a robotic cleaner configured to dock with a docking station. The robotic cleaning system includes a robotic cleaner, a dust cup configured to be removably coupled to the robotic cleaner, and a mop module configured to be removably coupled to the robotic cleaner. The robotic cleaner may be generally described as being configured to operate in a wet mode when the mop module is coupled to the robotic cleaner and to operate in a dry mode when the mop module is not coupled to the robotic cleaner.

The robotic cleaner may include a first set of charging contacts and a second set of charging contacts. The first and second sets of charging contacts are configured to electrically couple with the docking station such that a power supply (e.g., one or more batteries) of the robotic cleaner can be recharged. The mop module, when coupled to the robotic cleaner, may make one of the first set or the second set of charging contacts inaccessible by obscuring (e.g., extending over) or replacing a component (e.g., the dust cup) that includes one of the first set or the second set of charging contacts. In these instances, the robotic cleaner may be configured to electrically couple to the docking station using the accessible set of charging contacts. For example, the robotic cleaner may be configured to carry out a first charging contact docking behavior when the second set of charging contacts are inaccessible and to carry out a second charging contact docking behavior when the second set of charging contacts are accessible.

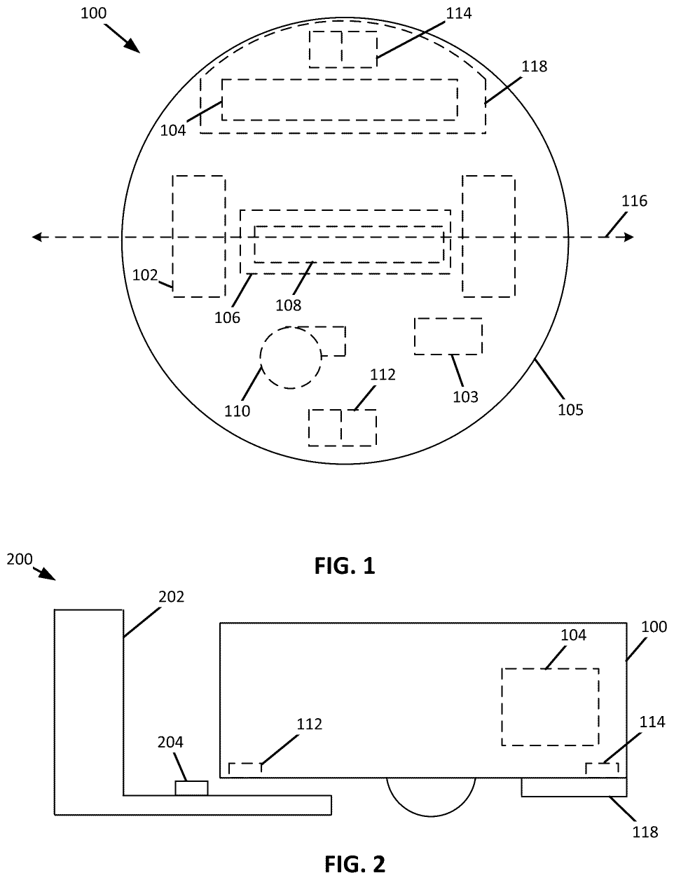

FIG. 1 is a schematic example of a robotic cleaner 100. The robotic cleaner 100 includes a plurality of driven wheels 102, a power supply (e.g., one or more batteries) 103, an agitator chamber 106 having an agitator 108 rotatable therein, and a suction motor 110 configured to configured to draw air through the agitator chamber 106. A dust cup 104 is configured to removably couple to a body 105 of the robotic cleaner 100 and is configured to fluidly couple to the suction motor 110 such that air flowing into the agitator chamber 106 passes through the dust cup 104 before entering the suction motor 110. As shown, the robotic cleaner 100 includes at least one of a first set of robot charging contacts 112 and/or a second set of robot charging contacts 114. For example, the dust cup 104 may include the second set of robot charging contacts 114 and the body 105 of the robotic cleaner 100 may include the first set of robot charging contacts 112. In this example, when the dust cup 104 is uncoupled from the robotic cleaner 100, the robotic cleaner 100 may include only the first set of robot charging contacts 112. By way of further example, both the first and second sets of robot charging contacts 112 and 114 may be coupled to the body 105 of the robotic cleaner 100. The first set of robot charging contacts 112 and the second set of robot charging contacts 114 may be positioned on opposite sides of a central axis 116 of the robotic cleaner 100. The central axis 116 may extend substantially (e.g., within 1°, 2°, 3°, 4°, or 5° of) parallel to a rotation axis of the driven wheels 102.

As shown, a mop module 118 may be configured to couple to the robotic cleaner 100. The mop module 118 may be configured to be coupled to the robotic cleaner 100 concurrently with or instead of the dust cup 104. When coupled to the robotic cleaner 100, at least a portion of the mop module 118 may cause the second set of robot charging contacts 114 to be inaccessible. For example, when coupled to the robotic cleaner 100, the mop module 118 may obscure (e.g., extend over) at least a portion of the second set of robot charging contacts 114. By way of further example, when the dust cup 104 includes the second set of robot charging contacts 114 and the mop module 118 replaces the dust cup 104 when coupled to the robotic cleaner 100, the robotic cleaner 100 may not include the second set of robot charging contacts 114 when the mop module 118 is coupled to the robotic cleaner 100. As such, coupling of the mop module 118 to the robotic cleaner 100 may generally be described as rendering the second set of robot charging contacts 114 inaccessible.

FIG. 2 shows a schematic side view of a robotic cleaning system 200 that includes the robotic cleaner 100 and a docking station 202 configured to electrically couple to the robotic cleaner 100. As shown, the docking station 202 includes a set of docking station charging contacts 204 that are configured to electrically couple to the first and second sets of robot charging contacts 112 and 114. When the mop module 118 is coupled to the robotic cleaner 100, the robotic cleaner 100 is configured to electrically couple to the docking station 202 with the first set of robot charging contacts 112. When the mop module 118 is not coupled to the robotic cleaner 100, the robotic cleaner 100 is configured to electrically couple to the docking station 202 with the second set of robot charging contacts 114. For example, when only the dust cup 104 of the mop module 118 and the dust cup 104 is coupled to the robotic cleaner 100, the robotic cleaner 100 is configured to electrically couple to the docking station 202 with the second set of robot charging contacts 114.

The robotic cleaner 100 may be configured to detect a presence of the mop module 118. For example, in response to detecting the presence of the mop module 118, the robotic cleaner 100 may be caused to dock according to a first charging contact docking behavior in which the robotic cleaner 100 electrically couples with the docking station 202 using the first set of robot charging contacts 112. In this example, the first charging contact docking behavior may correspond to a docking behavior in which the robotic cleaner 100 docks (e.g., forms an electrical coupling) with the docking station 202 while moving according to a forward movement direction. By way of further example, when the robotic cleaner 100 does not detect the presence of the mop module 118, the robotic cleaner 100 may be configured to dock according to a second charging contact docking behavior in which the robotic cleaner 100 electrically couples with the docking station 202 using the second set of robot charging contacts 114. In this example, the second charging contact docking behavior may correspond to a behavior in which the robotic cleaner docks with the docking station 202 while moving according to a rearward movement direction. The forward movement direction corresponds to the direction of movement that the robotic cleaner 100 travels in for a majority of a cleaning operation and the rearward movement direction is opposite the forward movement direction.

When docked with the docking station 202 (e.g., as a result of a docking behavior and/or user placement), the robotic cleaner 100 may be configured to determine an orientation of the robotic cleaner 100 relative to the docking station 202. For example, the robotic cleaner 100 may be configured to determine which of the first or second charging contacts 112 and 114 are electrically coupling the robotic cleaner 100 to the docking station 202. Additionally, or alternatively, the robotic cleaner 100 may be configured to determine whether the robotic cleaner 100 docked with the docking station 202 according to the first or second charging contact docking behavior. In response to the robotic cleaner 100 determining the orientation of the robotic cleaner 100 relative to the docking station 202, the robotic cleaner 100 determines an undocking behavior. For example, the robotic cleaner 100 may carry out an undocking behavior in which the robotic cleaner 100 moves in a rearward movement direction (e.g., if the first set of robot charging contacts 112 are electrically coupling the robotic cleaner 100 to the docking station 202) or in a forward movement direction (e.g., if the second set of robot charging contacts 114 are electrically coupling the robotic cleaner 100 to the docking station 202).

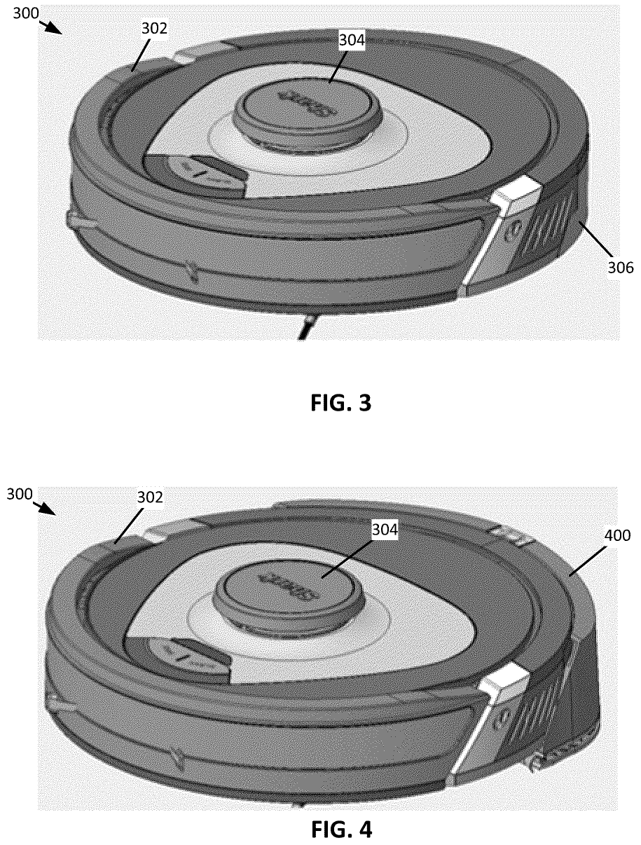

FIG. 3 shows a perspective view of a robotic cleaner 300 having a dust cup 306 removably coupled thereto and FIG. 4 shows another perspective view of the robotic cleaner 300 having a mop module 400 removably coupled thereto. As shown, the robotic cleaner 300 includes a displaceable bumper 302 and a navigation sensor 304 (e.g., a LIDAR sensor or a camera). The mop module 400, when coupled to the robotic cleaner 300, may extend around at least a portion of the dust cup 306. In these instances, both of the dust cup 306 and the mop module 400 may be coupled to the robotic cleaner 300. Alternatively, the mop module 400, when coupled to the robotic cleaner 300, may replace the dust cup 306. In these instances, only one of the mop module 400 or the dust cup 306 may be coupled to the robotic cleaner 300 at a time. The mop module 400 and displaceable bumper 302 may be disposed on opposing sides of the robotic cleaner 300.

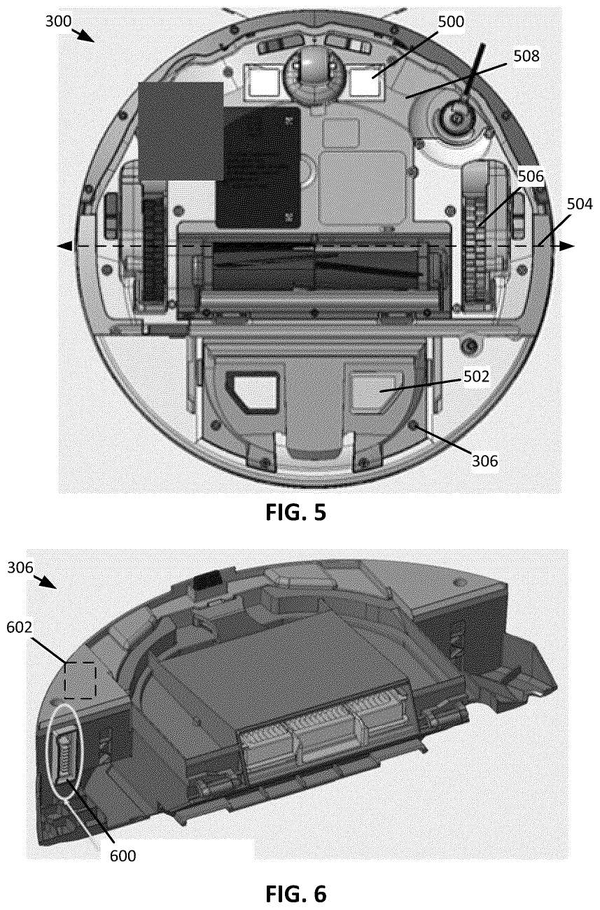

FIG. 5 shows a bottom view of the robotic cleaner 300 having the mop module 400 removed therefrom. As shown, the robotic cleaner 300 includes a first set of robot charging contacts 500 and a second set of robot charging contacts 502. The first set of robot charging contacts 500 and the second set of robot charging contacts 502 may be disposed on opposite sides of a rotation axis 504 of one or more driven wheels 506 of the robotic cleaner 300. In some instances, for example, the first set of robot charging contacts 500 may generally be referred to as forward charging contacts and the second set of robot charging contacts 502 may generally be referred to as rearward charging contacts.

The first set of robot charging contacts 500 may be coupled to a body 508 of the robotic cleaner 300 and the second set of robot charging contacts 502 may be coupled to the dust cup 306. As such, when the dust cup 306 is removed from the robotic cleaner 300, the second set of robot charging contacts 502 are removed from robotic cleaner 300. In some instances, the dust cup 306 may be replaced with an alternative dust cup or cleaning accessory (e.g., the mop module 400) that does not include a set of robot charging contacts. In these instances, the robotic cleaner 300 is configured to use the first set of robot charging contacts 500 for charging.

FIG. 6 shows a perspective front view of the dust cup 306. As shown, the dust cup 306 includes a dust cup electrical connector 600 configured to electrically couple to the robotic cleaner 300 (e.g., via a corresponding robotic cleaner electrical connector). The dust cup electrical connector 600 is configured to electrically couple the second set of robot charging contacts 502 to the robotic cleaner 300 (e.g., electrically couple the second set of robot charging contacts 502 to a power supply of the robotic cleaner 300). For example, the dust cup electrical connector 600 may be an 8-pin electrical connector. The robotic cleaner 300 may be configured to detect the presence of the dust cup 306 based on the dust cup electrical connector 600 forming an electrical coupling with the robotic cleaner electrical connector. For example, the robotic cleaner 300 can be configured to measure a resistive load of the dust cup electrical connector 600. In some instances, the resistive load may be a predetermined resistance value. In these instances, the robotic cleaner 300 can be configured to differentiate between the dust cup 306 and other accessories or dust cups that may interface with the robotic cleaner electrical connector based on the resistive load. In other words, dust cup electrical connector 600 may be generally described as having an identifying resistance value.

The dust cup electrical connector 600 may be further configured to transmit and/or receive data from the robotic cleaner 300. For example, the dust cup 306 may include one or more sensors 602. The one or more sensors 602 may include optical sensors (e.g., for obstacle detection and/or optical communication), magnetic sensors (e.g., hall effect sensors), and/or any other type of sensor. The one or more sensors 602 may be configured to detect a presence of the mop module 400 when the mop module 400 is configured to extend around at least a portion of the dust cup 306 when coupled to the robotic cleaner 300 (as opposed to replacing the dust cup 306). For example, the mop module 400 may include a magnetic component and the one or more sensors 602 may include a hall effect sensor configured to detect the magnetic field of the magnetic component.

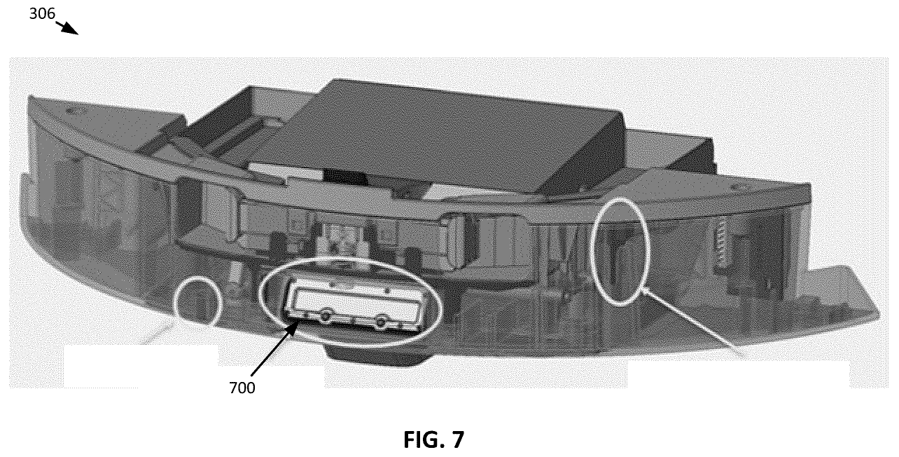

FIG. 7 shows a perspective rear view of the dust cup 306. As shown, the dust cup 306 includes an evacuation port 700. The evacuation port 700 is configured to fluidly couple with a docking station such that debris within the dust cup 306 is transferred to the docking station. As such, the identifying resistance value of the dust cup electrical connector 600 may correspond to that of an evacuation dust cup.

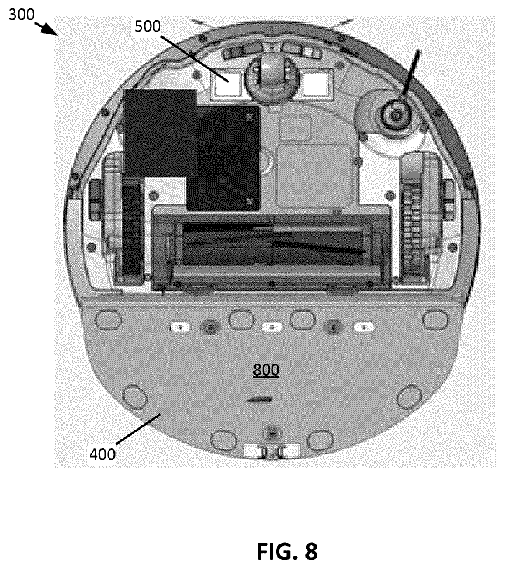

FIG. 8 shows a bottom view of the robotic cleaner 300 having the mop module 400 coupled thereto. The mop module 400 includes a mopping surface 800. When the mop module 400 is coupled to the robotic cleaner 300, the first set of robot charging contacts 500 are accessible and are capable of electrically coupling to a docking station and the second set of robot charging contacts 502 are inaccessible. For example, the mopping surface 800 can extend over the second set of robot charging contacts 502 (e.g., when the mop module 400 extends around at least a portion of dust cup 306). By way of further example, the mop module 400 may replace the dust cup 306 (the dust cup 306 including the second set of robot charging contacts 502), wherein the mop module 400 does not include a set of robot charging contacts. When the mop module 400 replaces the dust cup 306, the mop module 400 may have a mop module electrical connector having an identify resistance value that corresponds to the mop module 400, allowing the robotic cleaner 300 to identify the mop module 400.

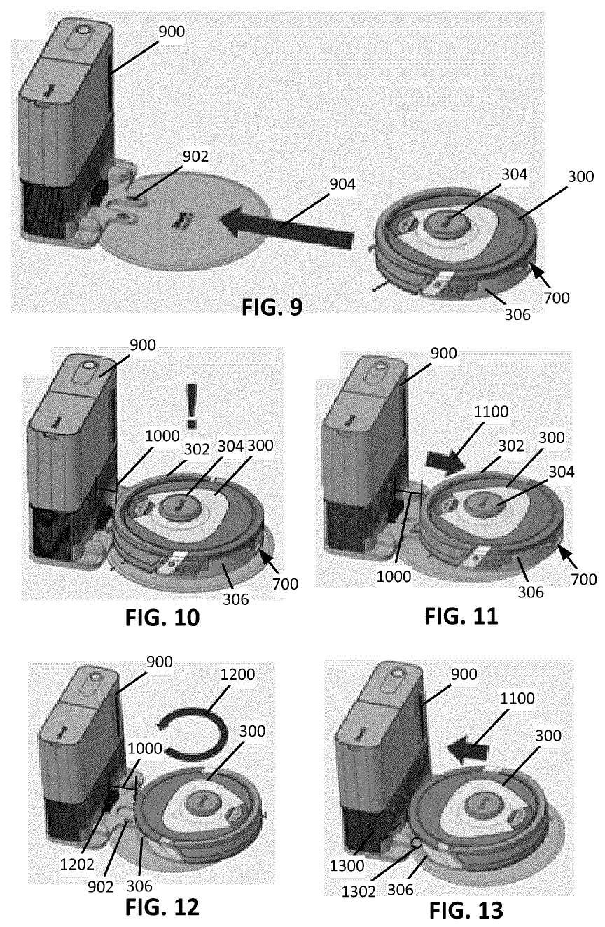

FIGS. 9-13 show the robotic cleaner 300 docking with a docking station 900, wherein the mop module 400 is not coupled to the robotic cleaner 300. The docking station 900 includes docking station charging contacts 902 configured to electrically couple to the first or second set of robot charging contacts 500 or 502. The docking station 900 can be further configured to evacuate the dust cup 306 of the robotic cleaner 300 when the robotic cleaner 300 docks with the docking station 900 according to an evacuation orientation. The robotic cleaner 300 can be configured to determine whether the mop module 400 is coupled to the robotic cleaner 300. When the mop module 400 is not coupled to the robotic cleaner 300, the second set of robot charging contacts 502 are accessible. If the robotic cleaner 300 determines that the mop module 400 is not coupled thereto, the robotic cleaner 300 is configured to carry out a second charging contact docking behavior. The second charging contact docking behavior is configured to electrically couple the second set of robot charging contacts 502 with the docking station charging contacts 902 and orient the robotic cleaner 300 in the evacuation orientation when docked. FIGS. 9-13 illustrate an example second charging contact docking behavior.

As shown in FIG. 9, the robotic cleaner 300 is configured to detect the docking station 900 and, in response to detecting the docking station 900, approach the docking station 900. The robotic cleaner 300 may detect the docking station 900 using one or more of a signal (e.g., an infrared signal) emitted by the docking station 900 and/or the navigation sensor 304. In response to detecting the docking station 900, the robotic cleaner 300 may be caused to approach the docking station 900 according to a forward movement direction 904.

As shown in FIG. 10, the robotic cleaner 300 moves according to the forward movement direction 904 and approaches the docking station 900 until a separation distance 1000 extending between the robotic cleaner 300 and the docking station 900 is less than (or equal to) a forward stopping threshold. The robotic cleaner 300 is caused to stop movement in the forward movement direction 904 in response to the separation distance 1000 being less than (or equal to) the forward stopping threshold. The robotic cleaner 300 can be configured to determine whether the separation distance 1000 is less than (or equal to) the forward stopping threshold using one or more of the navigation sensor 304 and/or the displaceable bumper 302.

As shown in FIG. 11, in response to the robotic cleaner 300 stopping after determining the separation distance 1000 is less than (or equal to) the forward stopping threshold, the robotic cleaner 300 is caused to move in a rearward movement direction 1100, the rearward movement direction 1100 being opposite the forward movement direction 904. The robotic cleaner 300 moves in the rearward movement direction 1100 until the separation distance 1000 is greater than (or equal to) a reverse stopping threshold. In response to the separation distance 1000 exceeding the reverse stopping threshold, the robotic cleaner 300 is caused to stop. The reverse stopping threshold may correspond to a separation distance from the docking station 900 that allows the robotic cleaner 300 to rotate relative to the docking station 900. The robotic cleaner 300 may be configured to determine when the separation distance 1000 is greater than (or equal to) the reverse threshold using one or more of the navigation sensor 304 and/or the displaceable bumper 302.

As shown in FIG. 12, in response to the robotic cleaner 300 stopping after determining the separation distance 1000 is greater than (or equal to) the reverse stopping threshold, the robotic cleaner 300 is caused to rotate according to a rotation direction 1200. The robotic cleaner 300 may rotate in the rotation direction 1200 until the evacuation port 700 of the dust cup 306 aligns with a suction port 1202 of the docking station 900. For example, the robotic cleaner 300 may be caused to rotate through a rotation of angle of substantially (e.g., within 1°, 2°, 3°, 4°, or 5° of) 180°.

As shown in FIG. 13, in response to the robotic cleaner 300 completing rotation in the rotation direction 1200, the robotic cleaner 300 moves according to the rearward movement direction 1100 until the evacuation port 700 comes into engagement (e.g., contact) with suction port 1202, fluidly coupling the dust cup 306 with the docking station 900, and/or until the robotic cleaner 300 is electrically coupled to the docking station 900. As such, the evacuation port 700 of the dust cup 306 may generally be described as being configured to fluidly couple with the suction port 1202 of the docking station 900.

When the dust cup 306 is fluidly coupled to the docking station 900, the second set of robot charging contacts 502 are configured to electrically couple the robotic cleaner 300 to the docking station charging contacts 902. The docking station 900 may include one or more dock sensors 1300 configured to detect a presence of the robotic cleaner 300. In some instances, the one or more dock sensors 1300 may be configured to determine whether the dust cup 306 is fluidly coupled to the docking station 900 and/or whether the second set of robot charging contacts 502 are electrically coupling the robotic cleaner 300 to the docking station 900. In response to the docking station 900 determining the dust cup 306 is fluidly coupled to the docking station 900, the docking station 900 may execute an evacuation behavior configured to transfer debris from the dust cup 306 into the docking station 900. In response to completing (or in response to commencing or before commencing) the evacuation behavior, the docking station 900 may be configured to determine whether the second set of robot charging contacts 502 are electrically coupling the robotic cleaner 300 to the docking station charging contacts 902. In response to determining that the second set of robot charging contacts 502 are electrically coupling the robotic cleaner 300 to the docking station charging contacts 902, the docking station 900 may be caused to supply power to the docking station charging contacts 902, recharging a power supply of the robotic cleaner 300. The one or more dock sensors 1300 may include hall effect sensors, current sensors, voltage sensors, resistance sensors, weight sensors, and/or any other type of sensor. For example, the one or more dock sensors 1300 may include a hall effect sensor configured to detect a magnetic component 1302 disposed within the dust cup 306. Additionally, or alternatively, the docking station 900 may be configured to detect that the dust cup 306 is fluidly coupled to the docking station 900 by detecting the electrical coupling between the second set of robot charging contacts 502 and the docking station charging contacts 902. In these instances, the electrical coupling between the second set of robot charging contacts 502 and the docking station charging contacts 902 may be used to form a digital communication link between the docking station 900 and the robotic cleaner 300. Additionally, or alternatively, the first set of robot charging contacts 500 and the docking station charging contacts 902 may be used to form a digital communication link. The digital communication link may be used, for example, to identify which of the first or second set of robot charging contacts 500 or 502 are electrically coupling the robotic cleaner 300 to the docking station 900.

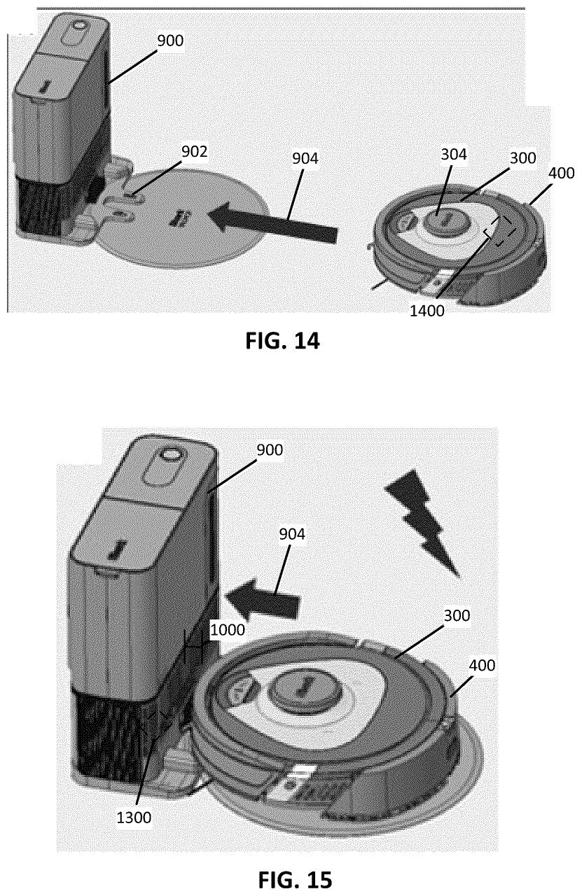

FIGS. 14 and 15 show the robotic cleaner 300 docking with the docking station 900, wherein the mop module 400 is coupled to the robotic cleaner 300. The robotic cleaner 300 can be configured to determine whether the mop module 400 is coupled to the robotic cleaner 300. For example, the mop module 400 may be configured to actuate a tactile switch when coupled to the robotic cleaner 300, interact with the robotic cleaner electrical connector, and/or to interact with a detection sensor 1400 (e.g., a hall effect sensor) of the robotic cleaner 300. When the mop module 400 is coupled to the robotic cleaner 300, the second set of robot charging contacts 502 are inaccessible (e.g., obscured by the mop module 400 or the mop module 400 replaced the dust cup 306, wherein the dust cup 306 includes the second set of robot charging contacts 502) and the robotic cleaner 300 may not be capable of fluidly coupling to the docking station 900. If the robotic cleaner 300 determines that the mop module 400 is coupled thereto, the robotic cleaner 300 is configured to carry out a first charging contact docking behavior. The first charging contact docking behavior is configured to electrically couple the first set of robot charging contacts 500 with the docking station charging contacts 902. FIGS. 14 and 15 illustrate an example first charging contact docking behavior.

As shown in FIG. 14, the robotic cleaner 300 is configured to detect the docking station 900 and, in response to detecting the docking station 900, approach the docking station 900. The robotic cleaner 300 may detect the docking station 900 using one or more of a signal (e.g., an infrared signal) emitted by the docking station and/or the navigation sensor 304. In response to detecting the docking station 900, the robotic cleaner 300 may be caused to approach the docking station 900 according to the forward movement direction 904.

As shown in FIG. 15, the robotic cleaner 300 moves according to the forward movement direction 904 and approaches the docking station 900 until the separation distance 1000 extending between the robotic cleaner 300 and the docking station 900 is less than (or equal to) a stopping threshold. The robotic cleaner 300 is caused to stop movement in the forward movement direction 904 in response to the separation distance 1000 being less than (or equal to) the stopping threshold. The robotic cleaner 300 can be configured to determine whether the separation distance 1000 is less than (or equal to) the stopping threshold using one or more of the navigation sensor 304 and/or the displaceable bumper 302.

When the robotic cleaner 300 stops moving in the forward movement direction 904, an electrical coupling is formed between the first set of robot charging contacts 500 and the docking station charging contacts 902. When docked in this orientation, the docking station 900 is configured to detect that the robotic cleaner 300 is docked in an orientation in which emptying of the dust cup 306 is not possible and/or that the dust cup 306 is not coupled to the robotic cleaner 300. For example, the one or more dock sensors 1300 may include a hall effect sensor configured to detect a magnetic component within the dust cup 306. When the robotic cleaner 300 is not in the correct orientation and/or the dust cup 306 is removed from the robotic cleaner 300, the hall effect sensor will not detect the magnetic component and the docking station 900 will not engage in the evacuation behavior.

As discussed in relation to FIGS. 9-15, the robotic cleaner 300 is configured to dock with the docking station 900 according to the first or second charging contacts docking behavior based, at least in part, on whether the mop module 400 and/or dust cup 306 is coupled to the robotic cleaner 300. When the robotic cleaner 300 is docked with (e.g., when electrically coupled to) the docking station 900, the robotic cleaner 300 can be configured to determine the orientation of the robotic cleaner 300 relative to the docking station 900 prior to commencing a cleaning operation (e.g., a wet cleaning or dry cleaning operation). For example, the robotic cleaner 300 can be configured to determine whether the first or second robot charging contacts 500 or 502 are electrically coupling the robotic cleaner 300 to the docking station 900, configured to determine whether the mop module 400 is installed in the robotic cleaner 300, configured to determine whether the dust cup 306 is configured to be evacuated by the docking station 900, and/or configured to store the orientation with which the robotic cleaner 300 docked with the docking station 900. Based on one or more of these determinations, the robotic cleaner 300 may be caused to undock from the docking station 900 using one of the forward movement direction 904 or the rearward movement direction 1100. For example, the robotic cleaner 300 can be configured to determine the orientation of the robotic cleaner 300 relative to the docking station 900 based, at least in part, on whether the first set of robot charging contacts 500 or the second set of robot charging contacts 502 are electrically coupling the robotic cleaner 300 to the docking station 900. In this example, if the first set of robot charging contacts 500 are electrically coupling the robotic cleaner 300 to the docking station 900, the robotic cleaner 300 undocks from the docking station 900 using the rearward movement direction 1100 and, if the second set of robot charging contacts 502 are electrically coupling the robotic cleaner 300 to the docking station 900, the robotic cleaner 300 undocks from the docking station 900 using forward movement direction 904.

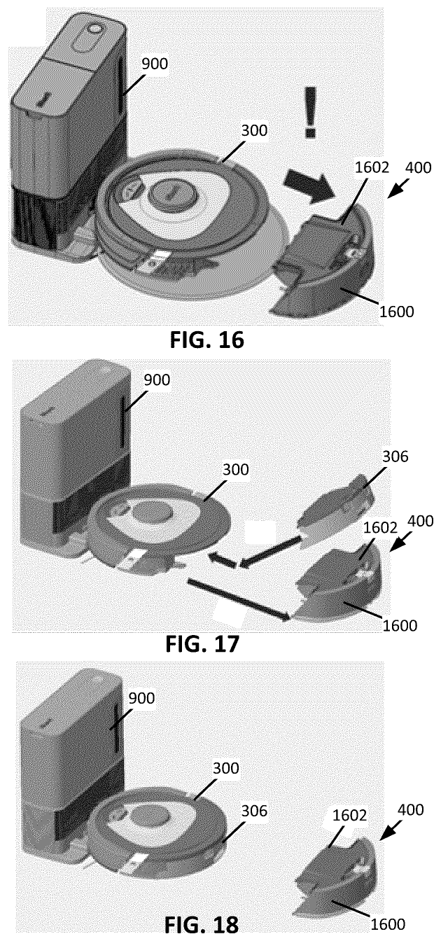

FIGS. 16-18 illustrate an example, wherein the mop module 400 is replaceable (e.g., by a user) while the robotic cleaner 300 is docked with the docking station 900. In other words, the mop module 400 is configured to be removed from the robotic cleaner 300 while the robotic cleaner 300 is electrically coupled to the docking station 900. In this example, the orientation of the robotic cleaner 300 relative to the docking station 900 may remain unchanged after the dust cup 306 is coupled to the robotic cleaner 300 until a cleaning operation is performed.

In the example of FIGS. 16-18, the mop module 400 may include a liquid tank 1600 and a dry debris collection chamber 1602. As such, the mop module 400 may be generally described as being capable of carrying out a wet and dry cleaning operation. Alternatively, the mop module 400 may include only the liquid tank 1600. In these instances, the liquid tank 1600 may shaped such that the dust cup 306 remains coupled to the robotic cleaner 300 and the liquid tank 1600 extends around at least a portion of the dust cup 306.

An example of a robotic cleaning system, consistent with the present disclosure, may include a docking station having a suction port, a robotic cleaner that includes at least one of a first set of robot charging contacts or a second set of robot charging contacts, the first and second sets of robot charging contacts being configured to electrically couple the robotic cleaner to the docking station, a dust cup configured to removably couple to the robotic cleaner, the dust cup including an evacuation port configured to fluidly couple with the suction port of the docking station, and a mop module configured to removably couple to the robotic cleaner. When the mop module is coupled to the robotic cleaner, the robotic cleaner may be configured to electrically couple to the docking station using the first set of robot charging contacts. When only the dust cup of the dust cup and the mop module is coupled to the robotic cleaner, the robotic cleaner may be configured to electrically couple to the docking station using the second set of robot charging contacts.

In some instances, the robotic cleaner may further include a plurality of driven wheels configured to rotate about a rotation axis and the first and second sets of robot charging contacts are disposed on opposite sides of the rotation axis. In some instances, the dust cup may include the second set of robot charging contacts. In some instances, the dust cup may include a dust cup electrical connector configured to electrically couple with the robotic cleaner. In some instances, the dust cup electrical connector may have an identifying resistance value. In some instances, only one of the dust cup or the mop module may be coupled to the robotic cleaner at a time. In some instances, the dust cup may include the second set of robot charging contacts. In some instances, when the robotic cleaner is electrically coupled to the docking station, the robotic cleaner may be configured to determine an orientation of the robotic cleaner relative to the docking station. In some instances, the robotic cleaner may be configured to determine the orientation of the robotic cleaner relative to the docking station based, at least in part, on whether the first set of robot charging contacts or the second set of robot charging contacts are electrically coupling the robotic cleaner to the docking station. In some instances, the mop module may be configured to be removed from the robotic cleaner while the robotic cleaner is electrically coupled to the docking station.

Another example of a robotic cleaning system, consistent with the present disclosure, may include a docking station, a robotic cleaner that includes at least one of a first set of robot charging contacts or a second set of robot charging contacts, the first and second sets of robot charging contacts being configured to electrically couple the robotic cleaner to the docking station, a dust cup configured to removably couple to the robotic cleaner, and a mop module configured to removably couple to the robotic cleaner. When the mop module is coupled to the robotic cleaner, the robotic cleaner may be configured to electrically couple to the docking station using the first set of robot charging contacts. When the mop module is not coupled to the robotic cleaner, the robotic cleaner may be configured to electrically couple to the docking station using the second set of robot charging contacts.

In some instances, the robotic cleaner further may include a plurality of driven wheels configured to rotate about a rotation axis and the first and second sets of robot charging contacts are disposed on opposite sides of the rotation axis. In some instances, the dust cup may include the second set of robot charging contacts. In some instances, the dust cup may include a dust cup electrical connector configured to electrically couple with the robotic cleaner. In some instances, the dust cup electrical connector may have an identifying resistance value. In some instances, only one of the dust cup or the mop module may be coupled to the robotic cleaner at a time. In some instances, the dust cup may include the second set of robot charging contacts. In some instances, when the robotic cleaner is electrically coupled to the docking station, the robotic cleaner may be configured to determine an orientation of the robotic cleaner relative to the docking station. In some instances, the robotic cleaner may be configured to determine the orientation of the robotic cleaner relative to the docking station based, at least in part, on whether the first set of robot charging contacts or the second set of robot charging contacts are electrically coupling the robotic cleaner to the docking station. In some instances, the mop module may be configured to be removed from the robotic cleaner while the robotic cleaner is electrically coupled to the docking station.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A robotic cleaning system comprising:
a docking station having a suction port;
a robotic cleaner that includes at least one of a first set of robot charging contacts or a second set of robot charging contacts, the first and second sets of robot charging contacts being configured to electrically couple the robotic cleaner to the docking station;
a dust cup configured to removably couple to the robotic cleaner, the dust cup including an evacuation port configured to fluidly couple with the suction port of the docking station; and
a mop module configured to removably couple to the robotic cleaner, wherein:
when the mop module is coupled to the robotic cleaner, the robotic cleaner is configured to electrically couple to the docking station using the first set of robot charging contacts; and
when only the dust cup of the dust cup and the mop module is coupled to the robotic cleaner, the robotic cleaner is configured to electrically couple to the docking station using the second set of robot charging contacts.

2. The robotic cleaning system of claim 1, wherein the robotic cleaner further includes a plurality of driven wheels configured to rotate about a rotation axis and the first and second sets of robot charging contacts are disposed on opposite sides of the rotation axis.

3. The robotic cleaning system of claim 1, wherein the dust cup includes the second set of robot charging contacts.

4. The robotic cleaning system of claim 3, wherein the dust cup includes a dust cup electrical connector configured to electrically couple with the robotic cleaner.

5. The robotic cleaning system of claim 4, wherein the dust cup electrical connector has an identifying resistance value.

6. The robotic cleaning system of claim 1, wherein only one of the dust cup or the mop module is coupled to the robotic cleaner at a time.

7. The robotic cleaning system of claim 6, wherein the dust cup includes the second set of robot charging contacts.

8. The robotic cleaning system of claim 1, wherein, when the robotic cleaner is electrically coupled to the docking station, the robotic cleaner is configured to determine an orientation of the robotic cleaner relative to the docking station.

9. The robotic cleaning system of claim 8, wherein the robotic cleaner is configured to determine the orientation of the robotic cleaner relative to the docking station based, at least in part, on whether the first set of robot charging contacts or the second set of robot charging contacts are electrically coupling the robotic cleaner to the docking station.

10. The robotic cleaning system of claim 1, wherein the mop module is configured to be removed from the robotic cleaner while the robotic cleaner is electrically coupled to the docking station.

11. A robotic cleaning system comprising:
a docking station;
a robotic cleaner that includes at least one of a first set of robot charging contacts or a second set of robot charging contacts, the first and second sets of robot charging contacts being configured to electrically couple the robotic cleaner to the docking station;
a dust cup configured to removably couple to the robotic cleaner; and
a mop module configured to removably couple to the robotic cleaner, wherein:
when the mop module is coupled to the robotic cleaner, the robotic cleaner is configured to electrically couple to the docking station using the first set of robot charging contacts; and
when the mop module is not coupled to the robotic cleaner, the robotic cleaner is configured to electrically couple to the docking station using the second set of robot charging contacts.

12. The robotic cleaning system of claim 11, wherein the robotic cleaner further includes a plurality of driven wheels configured to rotate about a rotation axis and the first and second sets of robot charging contacts are disposed on opposite sides of the rotation axis.

13. The robotic cleaning system of claim 11, wherein the dust cup includes the second set of robot charging contacts.

14. The robotic cleaning system of claim 13, wherein the dust cup includes a dust cup electrical connector configured to electrically couple with the robotic cleaner.

15. The robotic cleaning system of claim 14, wherein the dust cup electrical connector has an identifying resistance value.

16. The robotic cleaning system of claim 11, wherein only one of the dust cup or the mop module is coupled to the robotic cleaner at a time.

17. The robotic cleaning system of claim 16, wherein the dust cup includes the second set of robot charging contacts.

18. The robotic cleaning system of claim 11, wherein, when the robotic cleaner is electrically coupled to the docking station, the robotic cleaner is configured to determine an orientation of the robotic cleaner relative to the docking station.

19. The robotic cleaning system of claim 18, wherein the robotic cleaner is configured to determine the orientation of the robotic cleaner relative to the docking station based, at least in part, on whether the first set of robot charging contacts or the second set of robot charging contacts are electrically coupling the robotic cleaner to the docking station.

20. The robotic cleaning system of claim 11, wherein the mop module is configured to be removed from the robotic cleaner while the robotic cleaner is electrically coupled to the docking station.
